(19) United States
(12) Patent Application Publication
(10) Pub. No.: US 2006/0291430 A1
(43) Pub. Date: Dec. 28, 2006

(54) Mechanisms for speculatively allocated bandwidth in wireless networks

(75) Inventors: David Putzolu, Hillsboro, OR (US); Ian McCallum, Barrie (CA); Tomasz Madejski, Gdansk (PL)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/168,700

(22) Filed: Jun. 27, 2005

(51) Int. Cl. H04B 7/216

(52) U.S. Cl. 370/335; 370/342

(57) ABSTRACT

Embodiments of apparatuses, articles, methods, and systems for providing and/or using speculatively allocated bandwidth are generally described herein. Other embodiments may be described and claimed.

### FIELD

Embodiments of the present invention relate generally to the field of networks, and more particularly to mechanisms for allocating and/or using bandwidth in such networks.

### BACKGROUND

Wireless networks may include a number of network nodes in wireless communication with one another over a shared medium of the radio spectrum. One of the network nodes, e.g., a base station (BS), may have a scheduling mechanism to control access to the shared medium for a group of other network nodes, e.g., subscriber stations (SSs). In each frame, the scheduling mechanism may provide a downlink map (DL-MAP) that may alert the SSs to specific regions of a downlink portion of the current frame that are directed to them. A region may be defined by frequencies (e.g., subchannels) and time (e.g., modulation symbols). If data is being transmitted to a particular SS in the downlink portion of the frame, the SS may be alerted, by the DL-MAP, to energize its radio and decoder to receive and decode a region (e.g., subchannels 3-6 for symbols 20-35) that includes that data.

The scheduling mechanism may also provide an uplink map (UL-MAP) that may alert the SSs to regions of an uplink portion of a frame in which they are allowed to transmit data to the BS. However, unlike the DL-MAP, the UL-MAP is relevant to the following frame, rather than the current frame. That is, the regions that the UL-MAP directs the SSs to are in a frame that follows the frame in which the UL-MAP occupies. This latency may provide the SS with time to format the data it wishes to transmit into the region in which it is allowed to transmit.

An SS may alert the BS that it wishes to transmit a signal by using a contention-based bandwidth request. Each frame may have a contention region in its uplink portion that may be reserved for these contention-based bandwidth requests. An SS, wishing to transmit a signal to the BS, may upload a randomly selected code in the contention region. The code may simply alert the BS that an SS wishes bandwidth allocation, without conveying any information regarding the particular SS requesting the bandwidth or the amount of bandwidth that is needed to complete transmission. This is done as a code-division multiple access request (CDMA_REQ). The BS may, in a subsequent frame, provide notice to the sender of the CDMA_REQ of an allocation of preliminary bandwidth for an information element (CDMA_BW_ALLOC_IE) in an uplink portion of an upcoming frame. The CDMA_BW_ALLOC_IE may provide sufficient bandwidth for the SS to send a full bandwidth request (BW-REQ), which may convey more details about the SS itself and the resources necessary to complete its contemplated transmission. At that time the BS may allocate sufficient BW for the SS to upload its entire transmission segment in one or more following frames (BW-ALLOC). This contention-based request process is required anytime the SS wishes to transmit data (e.g., internet protocol packets, control traffic, etc.) to the BS.

The delays due to the UL-MAP relevancy coupled with the delays due to the contention-based bandwidth request may add significant time to a signaling exchange between a BS and an SS.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a network in accordance with an embodiment of the present invention;

FIG. 2 illustrates operation of a scheduling mechanism in accordance with an embodiment of the present invention;

FIG. 3 illustrates frame structures for communications of the network in accordance with an embodiment of the present invention;

FIG. 4 illustrates frame structures for communications of the network in accordance with another embodiment of the present invention;

FIG. 5 illustrates operation of the scheduling mechanism in accordance with another embodiment of the present invention;

FIG. 6 illustrates a subscriber station in accordance with an embodiment of the present invention; and

FIG. 7 illustrates operation of a subscriber station in accordance with an embodiment of the present invention.

### DETAILED DESCRIPTION

Illustrative embodiments of the present invention may include network nodes having mechanisms to provide and/or use speculative allocated bandwidth to/from other network nodes.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

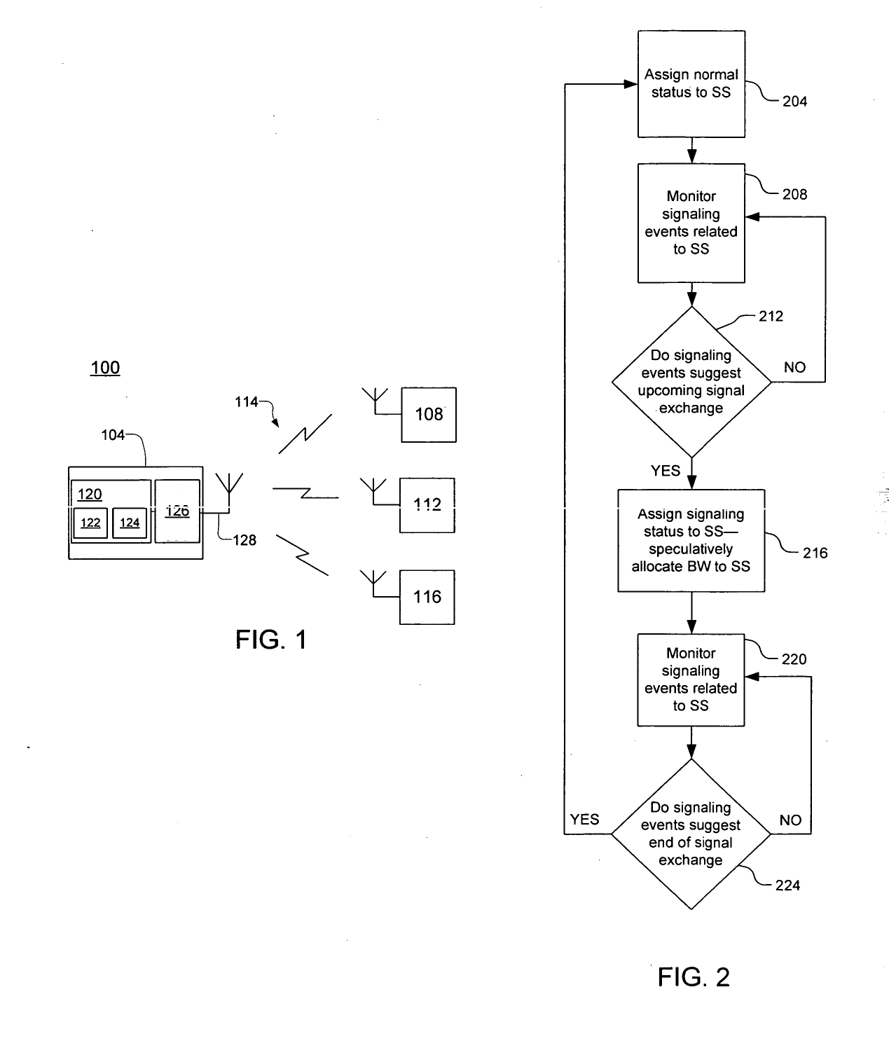

FIG. 1 illustrates a network 100 having network nodes 104, 108, 112, and 116 communicatively coupled to each other through a wireless network medium 114 in accordance with an embodiment of the present invention. In this embodiment, the network node 104 may control access to one or more frequency channels of the network medium 114 for the network 100 and may also be referred to as a base station 104. The network nodes 108, 112, and 116 may each communicate with the base station 104 as directed by the base station 104, and may hereinafter also be referred to as subscriber station 1 (SS1) 108, SS2 112, and SS3 116.

The base station 104 may have a scheduling mechanism 120, which may be a part of the node's media access control (MAC) layer. The scheduling mechanism 120 may develop a schedule to coordinate data transfers to/from the SSs 108, 112, and 116. In one embodiment, the scheduling mechanism 120 may include a processing device 122, which may include, e.g., a processor, a controller, an application-specific integrated circuit, etc., and a storage medium 124. The storage medium 124 may include instructions, which, when executed by the processing device 122 cause the scheduling mechanism 120 to perform various scheduling, assigning, and/or coordination functions. In one embodiment the processing device 122 and the storage medium 124 may be co-located on the same integrated circuit. In another embodiment, the storage medium 124 may be located on a separate integrated circuit. In various embodiments, the processing device 122 may be a dedicated or a shared resource for the scheduling mechanism 120.

In one embodiment, the scheduling mechanism 120 may speculatively allocate bandwidth of the network medium 114 to an SS, e.g., SS1 108, for the uploading of data to the base station 104. This speculative allocation, which may be based at least in part on a status assigned to the SS1 108, may be done in anticipation of the upcoming signaling exchange without requiring the reception of a bandwidth request from the SS1 108. That is, speculative allocation of bandwidth may be bandwidth allocated based at least partially on conjecture of upcoming need and not necessarily in response to a specific request for bandwidth. Depending on the amount of bandwidth speculatively allocated, the SS1 108 may avail itself of this bandwidth by either uploading its entire transmission to the base station 104 or by making a request for bandwidth sufficient to upload entire transmission to the base station 104.

The scheduling mechanism 120 may communicate said schedule through a wireless network interface 126 and one or more antennas 128 coupled to the base station 104. The one or more antennas 128 may provide the wireless network interface 126 with communicative access to the network medium 114.

In one embodiment the one or more antennas 128 may include a plurality of directional antennas, which radiate or receive primarily in one direction (e.g., for 120 degrees), cooperatively coupled to one another to provide substantially omnidirectional coverage. In another embodiment, the one or more antennas 128 may include one or more omnidirectional antennas, which radiate or receive equally well in all directions.

The network 100 may comply with a number of topologies, standards, and/or protocols. In one embodiment, various interactions of the network 100 may be governed by a standard such as one or more of the ANSI/IEEE 802.16 standards (e.g., IEEE 802.16.2-2004 released Mar. 17, 2004) for metropolitan area networks (MANs), along with any updates, revisions, and/or amendments to such. A network, and components involved therein, adhering to one or more of the ANSI/IEEE 802.16 standards may be colloquially referred to as worldwide interoperability for microwave access (WiMAX) network/components. In various embodiments, the network 100 may additionally or alternatively comply with other communication standards.

FIG. 2 illustrates operation of the scheduling mechanism 120 in accordance with an embodiment of the present invention. As used herein, numerals within parentheses may refer to operational phases. In this embodiment, the scheduling mechanism 120 may initially assign an SS, e.g., SS1 108, a default “normal” status (204). The scheduling mechanism 120 may monitor events of the network 100 related to SS1 108 (208). Events that may be monitored may include but are not limited to, receipt of incoming data from the SS1 108 and/or transmission of outgoing data to the SS1 108. In various embodiments this incoming/outgoing data could be, but is not limited to, internet protocol (IP) packets and control traffic.

When an event occurs, the scheduling mechanism 120 may make a determination whether or not the event suggests an upcoming signal exchange between the base station 104 and the SS1 108 (212). If a monitored event does not suggest an upcoming signaling exchange, the scheduling mechanism 120 may continue to monitor the events (208). However, if the monitored event does suggest an upcoming signaling exchange, or even an increased probability of an upcoming signaling exchange in accordance with one embodiment, the scheduling mechanism 120 may assign a “signaling” status to the SS1 108 (216). In various embodiments, such an event, which may be referred to as an upgrade event, may be data transmitted to/from the SS1 108 from/to the base station 104 recognized as prompting one or more data transmissions from the SS1 108 to the base station 104. While the SS1 108 is assigned the signaling status, the scheduling mechanism 120 may speculatively allocate bandwidth for the SS1 108 in one or more frames.

While the SS1 108 is assigned the signaling status, the scheduling mechanism 120 may continue to monitor events related to SS1 108 (220). When an event occurs, the scheduling mechanism 120 may make a determination whether or not the event suggests an end to a current signaling exchange between the BS 104 and the SS1 108 (224). In various embodiments, such an event, which may be referred to as a downgrade event, may be data transmitted to/from the SS1 108 from/to the base station 104 that is recognized as the last of a transaction, the elapsing of a predetermined amount of time without receiving data transmitted from the SS1 108, etc.

When a downgrade event occurs the scheduling mechanism 120 may assign a normal status to the SS1 108. While the SS1 108 is assigned a normal status, the scheduling mechanism 120 may not speculatively allocate bandwidth. In an embodiment, a normal status assignment may not affect operation of the scheduling mechanism other than with respect to provision/nonprovision of speculatively allocated bandwidth.

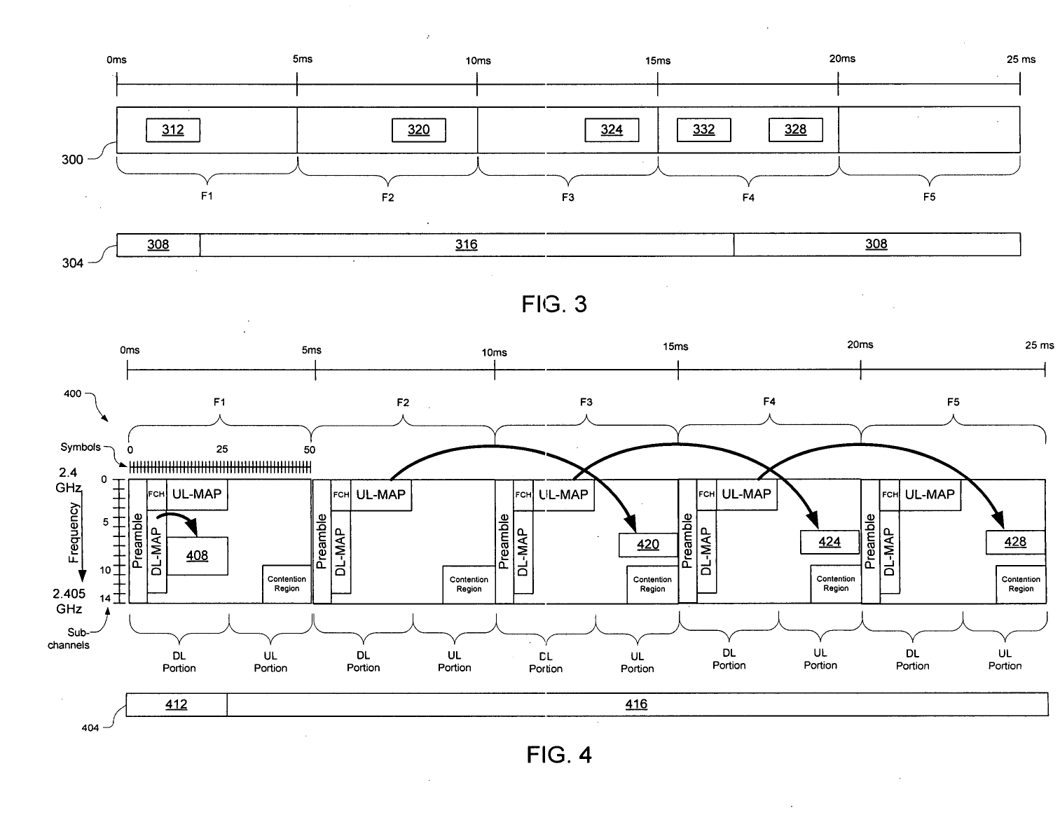

FIG. 3 illustrates frame structures 300 for communications of the network 100 along with a corresponding bar graph 304 depicting an assigned status of SS1 108, in accordance with an embodiment of the present invention. In this embodiment, SS1 108 may be initially assigned a normal status 308 by the scheduling mechanism 120. During a first frame F1, which may have a frame period of, e.g., approximately 5 milliseconds (ms), an upgrade event 312 may occur and be recognized by the scheduling mechanism 120. Based at least in part on the upgrade event 312, the scheduling mechanism 120 may assign the SS1 108 a signaling status 316.

In accordance with an embodiment of the present invention, the scheduling mechanism 120 may speculatively allocate bandwidth in one or more of the frames that occur while the SS1 108 is assigned the signaling status 316. For example, bandwidth regions 320, 324, and 328 may be speculatively allocated to SS1 108 in the second through fourth frames F2-F4, respectively. These regions 320, 324, and 328 may be dedicated to the SS1 108 whether or not SS1 108 actually uses or even needs them. SS1 108 may avail itself of the bandwidth of any/all of the regions 320, 324, and/or 328 for uploading data to the BS 104. This uploaded data may be, but is not limited to, IP packets and/or control traffic, which may include a further allocation request if the provided bandwidth is insufficient. Allocation of additional bandwidth, due to a further allocation request, may be appended to, or provided independent from, the regions 312, 316, and/or 320.

In the fourth frame F4, a downgrade event 332 may be recognized by the scheduling mechanism 120 as suggesting an end to a current signaling exchange. Based at least in part on the downgrade event 332, the scheduling mechanism 120 may reassign the SS1 108 the normal status 308. As in F1, the scheduling mechanism 120 may not speculatively allocate any bandwidth in F5 to SS1 108 due to its normal status. Note that in this embodiment the region 328 may have already been allocated for the fourth frame F4 when the downgrade event 332 occurs. Therefore, the downgrade event 332 may not affect this particular allocation.

While the above embodiment depicts the regions 320, 324, and 328 being in each of the frames that occur while the SS1 108 has a signaling status, other embodiments may adapt the speculative allocation such that the bandwidth is provided only in selected frames that occur while the SS1 108 has the signaling status. This adaptive speculation may be based on e.g., analysis of past signaling exchanges, to be described in further detail below. Additionally, while the above embodiment depicts the regions 320, 324, and 328 being approximately the same size, other embodiments may provide allocations of different sizes.

FIG. 4 illustrates frame structures 400 for communications of the network 100 along with a corresponding bar graph 404 depicting an assigned status of SS1 108 in accordance with another embodiment of the present invention.

The regions of the frame structures 400 and their interactions with other regions may be briefly described as follows. Frames may be divided by frequencies (e.g., subchannels 0-14) and by time (e.g., symbols 1-50). The frames, e.g., the first frame F1, may have both a downlink (DL) portion, including, e.g., symbols 1-25, and an uplink (UL) portion, including, e.g., symbols 26-50. It may be noted that, as shown, the DL portion and the UL portion time-share the same channel of the network medium 114 in a process referred to as Time-Division Duplexing (TDD). Other embodiments may use other processes to separate the DL and UL portions such as, but not limited to, Half-Frequency Division Duplexing (HFDD) and Frequency-Division Duplexing (FDD).

The scheduling mechanism 120 may begin each DL portion with a preamble. The preamble may be a known sequence of transmitted data to be used by the SSs for synchronization and channel estimation. The preamble may be followed by a frame control header (FCH), a DL-MAP, and an UL-MAP. The FCH may include a DL Frame Prefix to specify the burst profile and the length of the DL-MAP.

The DL-MAP may include, as briefly mentioned above, a schedule of the DL portion of the current frame. For example, in this embodiment, the BS 104 may be transmitting data to SS1 in the DL portion. Therefore, the scheduling mechanism 120 may use the DL-map to direct the SS1 108 to energize its radio to a region 408 of the DL portion in which the data is transmitted, e.g., subchannels 7-10 for symbols 11-25 of the first frame F1. The DL-MAP may also direct the SSs to the region of the DL-portion of the first frame F1 that includes the UL-MAP.

The data transmitted from the BS 104 to the SS1 108 may be a signaling request. The scheduling mechanism 120 may recognize this signaling request as an event suggestive of an upcoming signaling exchange with the SS1 108, e.g., an upgrade event. For example, it may be expected that the request will be followed by a response, which, in turn, may be followed by an acknowledgment. In anticipation of this upcoming signaling exchange, the scheduling mechanism 120 may update the status of the SS1 104 from a normal status 412 to a signaling status 416, as shown in the bar graph 404.

While the SS1 108 is assigned the signaling status 416, the scheduling mechanism 120 may speculatively allocate bandwidth in anticipation of the SS1 108 uploading data to the BS 104, e.g., uploading response to the request. In this embodiment, the scheduling mechanism 120 may speculatively allocate bandwidth as a region 420 in the third frame F3 and communicate this allocation to the SS1 108 in the UL-MAP of the second frame F2. Note that in this embodiment, due to the UL-MAP relevancy being to the following frame, a speculative allocation of bandwidth in the second frame F2 may not be made known to the SS1 108 unless it was communicated in the first frame F2. Therefore, in this embodiment, the scheduling mechanism 120 may not speculatively allocate bandwidth in the second frame F2.

In this embodiment, regions 424 and 428 in the fourth frame F4 and the fifth frame F5, respectively, may also be speculatively allocated to SS1 108. The dedication of regions 424 and 428 to SS1 108 may be communicated to SS1 108 in the third frame F3 and fourth frame F4, respectively.

In this embodiment, after the SS1 108 receives and processes the request it may formulate a response to the request. Instead of going through a contention-based request involving, e.g., modulating a code into the contention zone as a CDMA_REQ, receiving CDMA_BW_ALLOC, sending BW_REQ, receiving BW_ALLOC, and sending the full data transmission, the SS1 108 may simply transmit the response in the regions 420, 424, and/or 428. This may facilitate a reduction of delays in signaling exchanges. This reduction of delays may be especially noticeable in signaling exchanges having a long series of messages exchanged between the base station 104 and the SS1 108. Such signaling exchanges could be of a type such as, but not limited to, network-entry signaling exchanges, hand-off signaling exchanges, and voice-over-internet-protocol signaling exchanges.

In the present embodiment, the SS1 108 may require a certain amount of time to process the request, to formulate a response, and to format the response into the allocated bandwidth. This amount of time may involve a number of factors such as the processing capabilities of the SS1 108, the nature of the request, the substance of the response, etc. Assuming, for example, it takes the SS1 108 approximately 20 ms to do these tasks, the first region that the SS1 108 may able to use may be the region 428 in the fifth frame F5. In various embodiments, the scheduling mechanism 120 may record this delay time and account for it in a subsequent signaling exchange involving the same circumstances (e.g., same station, same type of request, etc.). That is, the scheduling mechanism 120 may use this information to provide adaptive speculative allocations in future signaling exchanges. For example, in a subsequent signaling exchange of the same type the scheduling mechanism 120 may begin speculative allocations in the fifth frame F5, rather than the third frame F3.

In various embodiments, for one reason or another, an SS may not avail itself of any of the speculatively allocated bandwidth. In these embodiments, the scheduling mechanism 120 may take note of these SSs and refrain from speculatively allocating bandwidth to them in future signaling exchanges.

In various embodiments, a variety of adaptations similar to those described above may be implemented to facilitate the effective and efficient use of network resources.

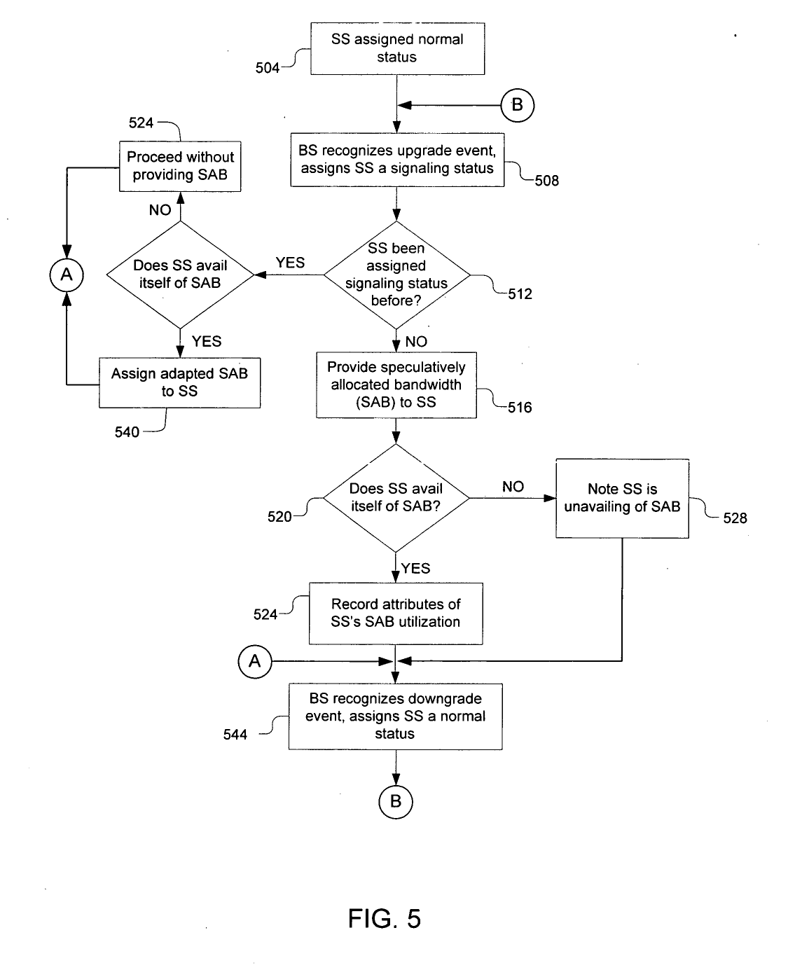

FIG. 5 illustrates operation of the scheduling mechanism 120 in accordance with another embodiment of the present invention. Description of the operational flow of this embodiment may begin with the scheduling mechanism 120 assigning a SS, e.g., SS1 108, a normal status (504). The base station 104, and more particularly the scheduling mechanism 120, may recognize an upgrade event, e.g., a signaling event that suggests an upcoming signaling exchange between the base station 104 and the SS1 108, and assign the SS1 108 a signaling status (508). The scheduling mechanism 120 may determine whether there is a record of the SS1 being assigned a signaling status before (512). In one embodiment, this determination may be done by reference to a database.

If there is not a record of the SS1 108 previously being assigned a signaling status, the scheduling mechanism 120 may speculatively allocate bandwidth to the SS1 108 in one or more upcoming frames (516). The scheduling mechanism 120 may then monitor whether or not the SS1 108 avails itself of the allocated bandwidth (520). If it does, the scheduling mechanism 120 may monitor and record utilization attributes (524). These attributes could include, but are not limited to, how many frames are typically needed for SS1 108 to formulate and transmit response to certain stimuli, how large typical data packets are in response to certain stimuli, etc. In one embodiment the scheduling mechanism 120 may store the recorded attributes in the database of the base station 104. If the SS1 108 does not use the speculatively allocated bandwidth, the scheduling mechanism 120 may record this information (528) for use at a later time.

Referring back to operational block 512, if it is determined that the SS1 108 has been assigned a signaling status before, the scheduling mechanism 120 may determine if it used speculatively allocated bandwidth in the past (532). If not, the scheduling mechanism 120 may proceed without providing such allocations (536), under the assumption that the SS1 108 is unable to take advantage of them. If the SS1 108 has used the SAB in the past, the scheduling mechanism 120 may provide SAB (540). In accordance with one embodiment, this SAB may be adapted based on recorded utilization attributes.

In various embodiments, the scheduling mechanism 120 may make a determination on whether or not providing SAB to an SS may facilitate quicker signaling exchanges in a number of ways. Additionally, this determination may be made prior to assigning a particular SS a signaling status in the first place. That is, if a particular SS has not used SAB in the past, the scheduling mechanism 120 may not assign a signaling status to that SS in the future.

The assigned signaling status session of the SS1 108 may be terminated by the BS 104, and more particularly the scheduling mechanism 120, after recognition of a downgrade event that is suggestive of an end of a current signaling exchange between the BS 104 and the SS1 108. At the recognition of a downgrade event, the scheduling mechanism 120 may assign the SS1 104 a normal status (544).

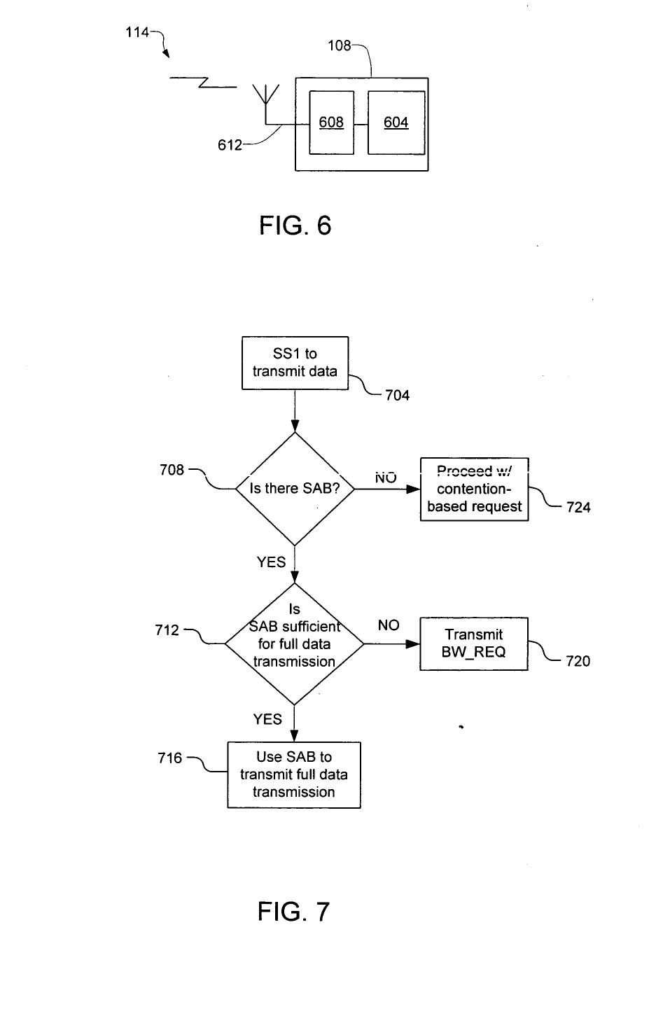

FIG. 6 illustrates the SS1 108 in more detail in accordance with an embodiment of the present invention. In this embodiment, the SS1 108 may have a transfer mechanism 604 to coordinate data transfers to/from the base station 104. Similar to the base station 104, the SS1 108 may have a wireless network interface 608 coupled to one or more antennas 612 to facilitate communication between the transfer mechanism 604 and the network medium 114.

Referring also to FIG. 7, if the SS1 108 wishes to transmit a data transmission to the base station 104 the data transfer mechanism 604, which may be a part of the SS1's 108 MAC layer, may receive an indication of this and proceed with obtaining sufficient bandwidth for said transmission (704). In one embodiment, the data transfer mechanism 604 may determine whether there has been any bandwidth speculatively allocated to SS1 108 (708). This may be done by referencing the DL-MAP transmitted by the base station 104. If bandwidth has been speculatively allocated to the SS1 108, the data transfer mechanism 604 may recognize this and utilize said bandwidth. In one embodiment the utilization of the bandwidth may be based at least in part on whether it is sufficient to accommodate the full data transmission (712). If so, the transfer mechanism 604 may cause the full data transmission to be uploaded to the base station 104 in the allocated bandwidth (716). If the speculatively allocated bandwidth is insufficient to accommodate full data transmission, the transfer mechanism 604 may upload a bandwidth request, e.g., BW_REQ, in the allocated bandwidth (720). Referring again to block (708), if there is no speculatively allocated bandwidth, the transfer mechanism 604 may proceed with a contention-based request, e.g., CDMA_BW_ALLOC (724).

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. An apparatus comprising:
a wireless network interface configured to transmit data to, and receive data from, a network node in wireless communication with the apparatus; and
a scheduling mechanism coupled to the wireless network interface and configured to provide a speculative allocation of bandwidth to the network node, based at least in part on an occurrence of an event, for the network node to transmit data to the apparatus.

2. The apparatus of claim 1, wherein the scheduling mechanism is further configured to assign a status to the network node based at least in part on the occurrence of the event, and to provide the speculative allocation of bandwidth based at least in part on the status of the network node.

3. The apparatus of claim 2, wherein the scheduling mechanism is further configured to assign a normal status to the network node based at least in part on an occurrence of an event suggestive of an end of a signaling exchange between the apparatus and the network node.

4. The apparatus of claim 2, wherein the scheduling mechanism is further configured to assign a signaling status to the network node based at least in part on an occurrence of an event suggestive of an upcoming signaling exchange between the apparatus and the network node.

5. The apparatus of claim 4, wherein the scheduling mechanism is further configured to provide the speculative allocation of bandwidth while the network node is assigned the signaling status.

6. The apparatus of claim 4, wherein the signaling exchange is a type of an exchange selected from the group consisting of a network-entry signaling exchange, a hand-off signaling exchange, and a voice-over-internet protocol signaling exchange and the speculative allocation of bandwidth is based at least in part on the type of the exchange.

7. The apparatus of claim 1, wherein the event is an event selected from the group consisting of a signaling event and a timer event.

8. The apparatus of claim 1, wherein the speculative allocation of bandwidth is based at least in part on a past signaling exchange between the apparatus and the network node.

9. The apparatus of claim 1, wherein the scheduling mechanism is further configured to develop an uplink map to communicate information about the speculative allocation of bandwidth to the network node.

10. A method comprising:
identifying, by a scheduling mechanism of a first network node, an occurrence of an event; and
speculatively allocating bandwidth of a wireless network medium to a second network node, based at least in part on the occurrence of the event, for the second network node to transmit data to the first network node.

11. The method of claim 10, further comprising:
developing an uplink map to communicate information about the speculatively allocated bandwidth to the second network; and
transmitting the uplink map to the second network node over the wireless network medium.

12. The method of claim 10, further comprising:
assigning, by the scheduling mechanism, a status to the second network node based at least in part on the event; and
speculatively allocating bandwidth to the second network node based at least in part on the status of the second network node.

13. The method of claim 12, wherein said occurrence of the event is suggestive of an upcoming signaling exchange between the first network node and the second network node, and said assigning of the status to the second network node further comprises:
assigning a signaling status to the second network node.

14. The method of claim 12, wherein said occurrence of the event is suggestive of an end of a signaling exchange between the first network node and the second network node, and said assigning of the status to the second network node further comprises:
assigning a normal status to the second network node.

15. The method of claim 10, wherein speculatively allocating bandwidth is based at least in part on a past signaling exchange between the first network node and the second network node.

16. The method of claim 10, wherein said speculative allocation of bandwidth is in a first signaling exchange, the method further comprising:
monitoring, by the scheduling mechanism, utilization of the speculatively allocated bandwidth in the first signaling exchange; and
speculatively allocating bandwidth in a second signaling exchange based at least in part on the utilization of the speculatively allocated bandwidth in the first signaling exchange.

17. The method of claim 16, wherein said monitoring of the utilization by the scheduling mechanism further comprises:
monitoring contention-based requests from the second network node during the first signaling exchange.

18. An article comprising:
a storage medium; and
instructions stored in the storage medium, which when executed by a processing device of a first network node, cause the processing device to
identify an occurrence of an event; and
speculatively allocate bandwidth of a wireless network medium to a second network node, based at least in part on the occurrence of the event, for the second network node to transmit data to the first network node.

19. The article of claim 18, wherein the instructions, which when executed, further cause the processing device to
assign a status to the second network node based at least in part on the occurrence of the event; and
speculatively allocate bandwidth to the second network node based at least in part on the assigned status of the second network node.

20. A system comprising:
a first network node having
a wireless network interface configured to transmit data to, and receive data from, a second network node in wireless communication with the first network node over a network medium; and
a scheduling mechanism coupled to the wireless network interface and configured to provide a speculative allocation of bandwidth to the second network node, based at least in part on an occurrence of an event, for the network node to transmit data to the first network node; and
a plurality of directional antennas coupled to the first network node and configured to provide access to the network medium.

21. The system of claim 20, wherein the scheduling mechanism is further configured to assign a status to the second network node based at least in part on the occurrence of the event, and to provide the speculative allocation of bandwidth based at least in part on the status of the network node.

22. The system of claim 21, wherein the first network node comprises a base station and the second network node comprises a subscriber station.

23. An apparatus comprising:
a wireless network interface configured to transmit data to, and receive data from, a network node in wireless communication with the apparatus; and
a transfer mechanism coupled to the wireless network interface and configured to determine whether bandwidth has been speculatively allocated to the apparatus.

24. The apparatus of claim 23, wherein the transfer mechanism is further configured to proceed with a contention-based request or utilization of speculatively allocated bandwidth based at least in part on determination of whether bandwidth has been speculatively allocated to the apparatus.

25. A method comprising:
receiving, with a transfer mechanism of a first network node, indication of a first data transmission to transmit to a second network node;
determining, by the transfer mechanism, whether bandwidth has been speculative allocated to the first network node.

26. The method of claim 25, further comprising:
proceeding with a contention-based request or utilization of speculatively allocated bandwidth based at least in part on said determining of whether bandwidth has been speculatively allocated to the first network node.
